(19) United States
(12) Patent Application Publication
(10) Pub. No.: US 2017/0327660 A1
(43) Pub. Date: Nov. 16, 2017

(54) THERMOPLASTIC POLYMERS FOAMED WITH A SEMICARBAZIDE

(71) Applicant: COLORMATRIX HOLDINGS, INC., Wilmington (DE)

(72) Inventors: Mark Dixon, Merseyside (GB); Christopher Small, Downpatrick (IE); Patrick Brown, Widnes, Cheshire (GB)

(21) Appl. No.: 15/533,794

(22) PCT Filed: Dec. 4, 2015
(86) PCT No.: PCT/GB2015/053719

§ 371 Date: Jun. 7, 2017

(30) Foreign Application Priority Data
Dec. 8, 2014 (GB) 1421805.1

(51) Int. Cl. C08J 9/10

(52) U.S. Cl. CPC C08J 9/105; C08J 2300/22; C08J 2203/04; C08J 2201/024; C08J 2201/03; C08J 2203/02

(57) ABSTRACT

A method of preparing a foamed thermoplastic polymer comprises contacting a chemical blowing agent (A) which is a semi-carbazide with a thermoplastic polymer or a precursor of a thermoplastic polymer. Blowing agent (A) is preferably p-toluenesulfonyl semi-carbazide and said polymer is preferably PVC. Formulations, including liquid formulations which include the blowing agent (A) and other ingredients, are also described.

This invention relates to thermoplastic polymers and particularly, although not exclusively, relates to the foaming of thermoplastic polymers, for example polyvinylchloride (PVC). Preferred embodiments relate to foamed sheets or profiles.

Foaming of polymers is a known technique in the polymer industry for the light-weighting of polymer components, improvement of electrical and thermal insulation properties, lower smoke generation, improved flammability behaviour and improved strength to weight ratio. In addition there are clear benefits in terms of reduced material usage and therefore lower cost for like parts when produced in foamed material compared to non-foamed components.

In general terms, there are two techniques used for the manufacture of polymer foams—physical and chemical foaming processes. Physical foaming of polymers is a process by which gas is injected directly into a polymer melt under high pressure during a processing operation. The extent of foaming is controlled by a number of factors including the solubility of the gas in the polymer, the use (or not) of nucleating agents, the quantity of gas injected into the melt and the pressure under which it is applied. The use of this type of foaming process requires the use of specialised equipment. In contrast, chemical foaming agents can be used, the action of which is reliant on the thermal decomposition and breakdown of the foaming agent to produce a gas that foams the polymer.

A wide range of chemical foaming agents is known with one of the most widely used being azodicarbonamide (AZDC). However, use of AZDC in some situations may lead to production of foams with poor thermal stability and/or foams produced may exhibit undesirable yellowing. This problem may be particularly observable when the thermoplastic polymer being foamed is PVC and/or wherein the polymer is stabilized against degradation (e.g. degradation during melt processing and/or during the lifetime of the foamed product) by a calcium-zinc-based stabiliser package.

It is an object of the present invention to address the above described problems.

According to a first aspect of the invention, there is provided a method of preparing a foamed thermoplastic polymer, the method comprising contacting a chemical blowing agent (A) which is a semi-carbazide with a thermoplastic polymer or a precursor of a thermoplastic polymer.

References to a state of a material herein (e.g. a liquid) refer to the state at standard temperature and pressure (STP).

A reference to “ppm” herein means “parts per million” by weight.

Said blowing agent (A) is preferably arranged to decompose to produce nitrogen gas. Said blowing agent (A) may decompose to produce carbon dioxide gas. Said blowing agent (A) is preferably arranged to decompose and produce nitrogen and carbon dioxide. A reference to a gas means a product which is gaseous at standard temperature and pressure (STP—i.e. 0° C. and 100.00 KPa). Said blowing agent (A) is preferably arranged to decompose to produce 1 mole of nitrogen per mole of blowing agent (A). Said blowing agent (A) is preferably arranged to decompose to produce 1 mole of carbon dioxide per mole of blowing agent (A).

Said blowing agent (A) may be arranged to decompose to produce a compound which is an antioxidant. Said blowing agent (A) may be arranged to decompose to produce a thiosulfinate.

Said blowing agent (A) is preferably an exothermic blowing agent.

Said blowing agent (A) may be of formula

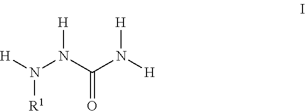

wherein R¹ represents a sulphonyl group containing moiety. Preferably R¹ includes a sulphonyl moiety. R¹ may represent a moiety

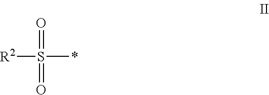

wherein the * represents the bond of moiety II by which R¹ is bonded to the nitrogen atom of the semi-carbazide of Formula I; and R² represents an aromatic group containing moiety. R² may include an optionally-substituted phenyl moiety. Said optionally-substituted phenyl moiety may be directly bonded to the sulphonyl group of moiety II. Said phenyl moiety may be substituted. In this case, the phenyl moiety may be substituted in its ortho position relative to position the phenyl moiety is bonded to the sulphonyl moiety. Said phenyl moiety may be substituted by one or more (preferably only one) alkyl moiety, for example a C₁₋₄ alkyl moiety. Said phenyl moiety is preferably substituted by a methyl group. Thus, preferably R² represents a toluene moiety and preferably R¹ represents a toluenesulfonyl moiety, especially a p-toluenesulfonyl moiety. Said blowing agent (A) is preferably p-toluenesulfonyl semi-carbazide.

The method preferably comprises contacting the chemical blowing agent (A) with said thermoplastic polymer during melt processing, for example extrusion of the polymer. Preferably the liquid formulation is introduced directly into an extruder, for example via a feed throat of the extruder.

Said method preferably comprises contacting said chemical blowing agent (A) with a thermoplastic polymer. Said thermoplastic polymer may be selected from polyolefins (e.g. polyethylene and polypropylene), polyvinylchloride (PVC) and thermoplastic elastomers (TPEs). Preferably, however, said thermoplastic polymer comprises PVC.

Preferably, the ratio of the wt % of PVC contacted with said chemical blowing agent (A) in the method divided by the total wt % of all thermoplastic polymers contacted with said chemical blowing agent (A) in the method is at least 0.8, preferably at least 0.9, more preferably at least 0.95. Preferably, the only thermoplastic polymer contacted with said chemical blowing agent (A) in the method is PVC.

When said thermoplastic polymer is PVC, in the method, a stabiliser formulation is suitably included for stabilising the PVC against degradation, for example by dechlorination.

Said stabiliser formulation preferably comprises a barium or calcium compound. Said stabiliser formulation may include a zinc compound. The amount (in moles) of said barium or calcium compound is suitably greater than the amount (in moles) of said zinc compound. Said stabiliser formulation may include a stearate. Said stabiliser formulation may include one or more compounds selected from barium stearate, calcium stearate, zinc stearate, mixed fatty acid salts (e.g. palmitates and laurates), barium alkyl phonates and zinc octoate. In one embodiment, said stabiliser may be a tin-based compound. In one preferred embodiment said stabiliser formulation comprises one or more compounds selected from barium stearate, calcium stearate and zinc stearate. Said stabiliser formulation preferably includes both a calcium compound and a zinc compound. Thus, said PVC is preferably calcium-zinc stabilised.

In the method, melt-processing is preferably undertaken at a temperature of at least 170° C. or preferably at least 190° C. During melt-processing, the temperature may not exceed 250° C. or, preferably, may not exceed 220° C.

Suitably at least 0.05 parts by weight (pbw) of said chemical blowing agent (A) is contacted with 100 pbw of said thermoplastic polymer in the method. Less than 0.4 pbw of said chemical blowing agent (A) may be contacted with 100 pbw of said thermoplastic polymer in the method. Preferably 0.09 to 0.3 pbw of said chemical blowing agent (A) is contacted with 100 pbw of said thermoplastic polymer in the method.

The sum of the pbw of calcium and zinc compounds (which are suitably for stabilising PVC against degradation as described) which are associated with 100 pbw of said thermoplastic polymer in the method is suitably at least 0.01 pbw, preferably at least 0.02 pbw; the sum may be less than 0.1 pbw; it is preferably in the range of 0.03 to 0.07 pbw.

Suitably, at least 0.2 pbw (preferably 0.2 to 1.1 pbw) of bicarbonate (e.g. sodium bicarbonate) is contacted with 100 pbw of said thermoplastic polymer in the method.

The sum of the pbw of exothermic chemical blowing agents contacted with 100 pbw of said thermoplastic polymer in the method is suitably at least 0.08 pbw, preferably at least 0.1 pbw. Said sum may be less than 1.0 pbw or less than 0.5 pbw per 100 pbw of said thermoplastic polymer. Exothermic chemical blowing agents may include the chemical blowing agent (A) and chemical blowing agent (B) referred to herein.

Suitably, less than 0.15 pbw (preferably less than 0.05 pbw, more preferably 0 pbw) of azodicarbonamide (AZDC) is contacted with 100 pbw of said thermoplastic polymer in the method.

According to a second aspect of the invention, there is provided a formulation for foaming a thermoplastic polymer, said formulation comprising:

a carrier; and

a chemical blowing agent (A) which is a semi-carbazide.

The chemical blowing agent (A) of the second aspect may have any feature of said chemical blowing agent (A) of the first aspect.

Said formulation of the second aspect may comprise a solid formulation or a liquid formulation. A solid formulation may be a masterbatch, suitably for use in the method of the first aspect. A liquid formulation may include a liquid carrier and said chemical blowing agent (A). Preferably, said formulation is a liquid formulation.

Said carrier is preferably an organic liquid. Said carrier suitably has a boiling point of greater than 150° C., preferably greater than 200° C. In some cases, the boiling point may be greater than 300° C. Said carrier may be selected from oils, esters and fatty acids. Preferred oils may be vegetable or mineral oils, with the latter being especially preferred. Esters may be fatty acid esters, phthalates or mellitate esters. Said carrier is preferably a mineral oil.

In said formulation (e.g. said liquid formulation), the ratio of the parts by weight (pbw) of carrier divided by the pbw of said blowing agent (A) may be in the range 0.5 to 5, preferably in the range 1 to 3, especially 1.0 to 2.5.

Said formulation (e.g. said liquid formulation) preferably comprises a dispersion, wherein suitably said blowing agent (A) is dispersed in said carrier. Solids in said formulation (e.g. said liquid formulation) are suitably in a finely divided form.

Said formulation (e.g. said liquid formulation) preferably includes at least 5 wt %, more preferably at least 10 wt % of said blowing agent (A). Said formulation (e.g. said liquid formulation) may include less than 25 wt % or less than 20 wt % of blowing agent (A).

Said formulation (e.g. said liquid formulation) may include one or a plurality of endothermic chemical blowing agents. The formulation (e.g. said liquid formulation) may include at least 30 wt %, suitably at least 35 wt %, preferably at least 50 wt % of endothermic blowing agents. The formulation may include 60 wt % or less, preferably 55 wt % or less, of endothermic blowing agents. Said one or said plurality of endothermic blowing agents is preferably dispersed in said carrier.

An endothermic blowing agent may be a bicarbonate, for example sodium bicarbonate.

Said formulation (e.g. said liquid formulation) may comprise at least 20 wt %, suitably at least 30 wt %, preferably at least 40 wt %, more preferably at least 50 wt % of a bicarbonate, for example an alkali metal bicarbonate such as sodium bicarbonate. Said bicarbonate is preferably dispersed in said carrier. Said formulation (e.g. said liquid formulation) may include less than 70 wt % or less than 60 wt % of said bicarbonate.

The ratio of the sum of the wt % of exothermic blowing agent(s) divided by the sum of the wt % of endothermic blowing agent(s) in said formulation (e.g. said liquid formulation) may be in the range 0.1 to 1, preferably in the range 0.2 to 0.5.

The sum of the amounts of solid materials dispersed in the formulation (e.g. said liquid formulation) is suitably in the range 50 to 85 wt %, preferably 60 to 80 wt %.

Said formulation (e.g. said liquid formulation) may include at least 15 wt %, preferably at least 20 wt %, more preferably at least 23 wt % carrier. It may include less than 40 wt %, preferably less than 35 wt %, more preferably less than 30 wt % carrier. The total level of liquid in the formulation may be in the range 15 to 50 wt %, preferably 20 to 40 wt %.

The formulation (e.g. said liquid formulation) may include at least 10 wt %, suitably at least 12 wt %, of exothermic blowing agents. The formulation (e.g. said liquid formulation) may include 30 wt % or less; or 26 wt % or less of exothermic blowing agents.

Said formulation (e.g. said liquid formulation) may include a chemical blowing agent (B) which may be an exothermic chemical blowing agent.

Said exothermic chemical blowing agent suitably includes said blowing agent (A) and it may include said chemical blowing agent (B). Said chemical blowing agent (B) may include a hydrazide, for example, oxybissulphonyl hydrazide (OBSH). Said formulation (e.g. said liquid formulation) may include at least 1 wt %, preferably at least 2 wt % of chemical blowing agent (B), for example said hydrazide. It may include less than 10 wt % or less than 8 wt % of chemical blowing agent (B), for example said hydrazide.

Said formulation (e.g. said liquid formulation) suitably includes less than 10 wt %, preferably less than 1 wt %, more preferably 0 wt % of azodicarbonamide (AZDC).

The total amount of chemical blowing agents in said formulation (e.g. said liquid formulation) may be at least 30 wt %, is suitably at least 40 wt %, is preferably at least 50 wt %, is more preferably at least 60 wt %, and is especially at least 65 wt %. Said total amount may be 90 wt % or less, 80 wt % or less, or 75 wt % or less.

A said liquid formulation suitably includes a surface active agent, for example a surfactant. A said liquid formulation may include at least 1 wt %, suitably at least 2.5 wt %, preferably at least 3.5 wt % surfactant. The amount of surfactant may be less than 10 wt %, less than 8 wt % or less than 6 wt %. A surface active agent may comprise fatty acid esters of polyethylene glycols and polypropylene glycols; dialkyl terminated polyethylene glycol; and hyperdispersants such as Solsperse 11000.

A preferred liquid formulation may include:
15 to 40 wt % carrier, preferably mineral oil;
30 to 70 wt % of a bicarbonate (preferably sodium bicarbonate);
5 to 25 wt % (preferably 8 to 20 wt %) of chemical blowing agent (A).

Said preferred liquid formulation may include 2 to 10 wt % of OBSH.

An especially preferred liquid formulation may include:
20 to 30 wt % of carrier;
8 to 25 wt % of toluenesulfonyl semi-carbazide,
a bicarbonate (e.g. sodium bicarbonate), wherein the total amount of bicarbonate in the formulation is in the range 25 to 65 wt %, for example in the range 25 to 55 wt %.

Said liquid formulations may include other components such as thickening agents, stabilizing agents and/or colours.

Said liquid formulation suitably includes at least 1 wt %, preferably at least 2 wt % of metal oxides; it may include less than 12 wt % or less than 5 wt % of metal oxides. Metal oxides may be selected from calcium oxide and zinc oxide. Said formulation may include 0.5 to 3 wt % of calcium oxide and 1 to 10 wt % of zinc oxide. The sum of the amounts of the aforementioned oxides is preferably less than 12 wt % or less than 10 wt %.

Said formulation (e.g. said liquid formulation of the second aspect) is preferably suitable for foaming PVC. It may be for use in the manufacture of PVC foamed sheets.

Preferably, said formulation of the second aspect is used in said method of the first aspect. Thus, said method of said first aspect may comprise contacting said formulation of the second aspect (which includes said chemical blowing agent (A) as described), with a thermoplastic polymer or precursor of a thermoplastic polymer as described. In a preferred embodiment, said method of the first aspect comprises contacting a said liquid formulation of the second aspect with a said thermoplastic polymer as described in the first aspect.

The let-down ratio (LD) may be defined as:

LD=wt % of liquid formulation used in the method
total wt % of all thermoplastic polymers (e.g. PVC) contacted with said liquid formulation in the method.

Suitably, LD is in the range 0.001 to 0.05, preferably in the range 0.0015 to 0.03, more preferably in the range 0.0015 to 0.02.

In the method of the first aspect, said liquid formulation is preferably used and suitably produces a gas for foaming the thermoplastic polymer. Said liquid formulation preferably produces nitrogen. Said liquid formulation preferably produces carbon dioxide. Note that, in the context, water is not regarded as a gas since it is not gaseous at STP.

The method of the first aspect preferably comprises preparing a foamed PVC which may be in the form of a sheet or profile, especially a sheet.

In a third aspect, there is provided a foamed product made in the method of the first aspect.

In a fourth aspect, there is provided a foamed product comprising:

(i) a thermoplastic polymer (especially PVC)

(ii) a thiosulfinate.

Said foamed product is preferably extruded.

PVC used as described herein preferably has a K value in the range K40-K80, more preferably K50-K70.

Said foamed product suitably includes at least 100 ppm, preferably at least 200 ppm, more preferably at least 250 ppm of thiosulfinate. Said foamed product may include less than 1000 ppm or less than 500 ppm of thiosulfinate.

Said foamed product suitably includes at least 100 ppm, preferably at least 200 ppm, more preferably at least 250 ppm of thiosulfinate relative to the weight of PVC in said foamed product. Said foamed product may include less than 1000 ppm, or less than 500 ppm of thiosulfinate relative to the weight of PVC.

Said foamed product may include at least 1 ppm, for example at least 10 ppm, of a calcium compound. Said foamed product may include at least 1 ppm, for example at least 10 ppm, of a zinc compound. Said foamed product may include a zinc/calcium stabiliser which includes less than 0.3 wt %, preferably less than 0.25 wt %, more preferably less than 0.2 wt % of tin metal (Sn). Said foamed product suitably includes no detectable level of tin metal (Sn).

Said foamed product may be a foamed PVC stabilised by a calcium-zinc combination.

When the foamed product is produced using a liquid formulation as described, said foamed product may include residual vehicle, for example an organic liquid as described in the second aspect.

The foamed product may include at least 1 ppm or at least 5 ppm of residual vehicle.

Specific embodiments of the invention will be described, by way of example.

The following material is referred to hereinafter:

PVC—refers to PVC having a K value of K57.

In the following examples, Example 1 describes general method of preparing liquid formulations for foaming PVC; Example 2 describes formulations made and tested; Example 3 describes testing of formulations; Example 4 describes preparation of foams; Examples 5 describes testing of foams; Example 6 provides a comparison of formulations, including the formulation of Example 7; and Examples 8 to 13 provide details on other formulations.

### EXAMPLE 1—GENERAL METHOD FOR PREPARATION OF LIQUID FORMULATIONS

Liquid formulations were prepared in a plastic container by initially mixing the ingredients by hand under ambient conditions, to incorporate the solid materials into liquid carrier. Subsequent mixing was continued using a Hamilton Beach high speed laboratory mixer until a stable homogenous dispersion had been prepared.

### EXAMPLE 2 AND COMPARATIVE EXAMPLE 1—LIQUID FORMULATIONS TESTED

The general procedure described in Example 1 was used to prepare liquid formulations from the ingredients referred to in Table 1. Note that the formulation of Comparative Example C1 is the same as a currently commercially available formulation.

TABLE 1

| | | Comparative |
|---|---|---|
| | Example 2 | Example C1 |
| | (amount wt %) | (amount wt %) |
| Liquid carrier | 24.1 | 24.1 |
| Dispersant | 4.25 | 4.25 |
| Sodium bicarbonate | 53 | 53 |
| Calcium oxide | 0.9 | 0.9 |
| Zinc oxide | 2.4 | 2.4 |
| OBSH (4,4′oxybis | 2.6 | 2.6 |
| (benzenesulfonylhydrazide) | | |
| TSSC (p-toluenesulfonylsemicarbazide) | 12 | 0 |
| AZDC | 0 | 12 |
| Fumed silica (thickener) | 0.75 | 0.75 |

### Testing of Materials

### Test 1—Assessment of PVC Degradation Times

The liquid formulations of Example 2 and Comparative Example C1 were tested in association with PVC to assess the effect on the speed of degradation of the PVC.

In the test, 65 g of a dry blend of a PVC, stabilised by a proprietary calcium-zinc stabiliser package, was weighed into a container. 1 wt % of a liquid formulation to be assessed was added to the container and mixed manually, using a spatula, with the PVC. The mixture was then added into a Haake torque rheometer and tested at a speed of 50 rpm, over the temperature range 160-190° C. The torque curve was observed over time after the first gelation peak. In general terms, the torque increases over time due to thermal degradation. Decomposition time was determined as the time when the torque after gelation reaches a value which is 10% greater than the torque minimum.

### EXAMPLE 3—TESTING OF FORMULATIONS

The formulations of Example 2 and Comparative Example C1 were added to PVC as described in Test 1 and tested as described. In addition virgin PVC (in the absence of any additive) (referred to as “Comparative Example C2”) was tested in the same way. PVC degradation times are reported in Table 2.

TABLE 2

| Example No. | PVC degradation time(s) |
|---|---|
| Using Example 2 formulation | 2830 |
| Using Comparative Example C1 formulation | 2457 |
| Comparative Example C2 (virgin PVC) | 2550 |

It should be noted from Table 2 that, by using the Example 2 formulation, the PVC takes longer to degrade (compared to Comparative Examples C1 and C2), suggesting the use of the formulation of Example 2 in foaming will result in foamed parts which have a fine cell structure and a clean white appearance. In particular, foams produced using the Example 2 formulation may be advantageous compared to foams produced using the Example C1 formulation which differs from the Example 2 formulation only in that the Example 2 formulation includes TSSC whereas the Example C1 formulation includes AZDC. Thus, use of TSSC in liquid formulations as described leads to production of improved foams.

### EXAMPLE 4—PREPARATION OF FOAMS

Samples for foaming were prepared by weighing out 250 g of a dry blend of a PVC, stabilised by a proprietary calcium-zinc stabilizer package and adding 1 wt % of selected liquid formulations. The ingredients were mixed using a Waring High Speed Lab Blender for 1 minute at low speed, followed by 1 minute at high speed.

An extruder with a temperature profile as follows was started: Zone 1—170° C., Zone 2—175° C., Zone 3—180° C., Die 180° C., The RPM was increased to a set-point of 17.5 rpm. Selected mixtures including the liquid formulations as described were added to the extruder and after 3-4 minutes samples were cut and collected at the exit of the die and cooled between two metal plates.

### EXAMPLE 5—TESTING OF FOAMS

Foams produced as described in Example 4 were tested as follows:

Density—cut sections were measured for density using a Alfa Mirage Densimeter.

Colour—measured using Minolta 3600d spectrophotometer, with virgin PVC resin as reference, Colour difference is quoted as ΔE.

Results are reported in Table 3.

TABLE 3

| Example No. | | | |
|---|---|---|---|
| of formulation used in | | | ΔE* compared to |
| foaming | Density g/cm³ | Colour | Virgin PVC |
| 2 | 0.5404 | White | 1.64 |
| C1 | 0.5074 | Light Yellow | 9.73 |
| Virgin PVC | 1.38 | White | — |

The results in Table 3 illustrate that use of the liquid formulation of Example 2, leads to similar density reduction in the foams produced as for the existing commercially-available formulation of Example C1. However, advantageously, use of the liquid formulation of Example 2 leads to a whiter foam product which is generally white like virgin PVC and has a ΔE* which differs far less from Virgin PVC compared to the ΔE* difference when the Example C1 formulation is used to foam the PVC.

### EXAMPLE 6—COMPARISON OF OTHER FORMULATIONS

The general procedure of Example 1 was used to prepare liquid formulations from the ingredients in Table 4.

TABLE 4

| | Example 7 | Comparative |
|---|---|---|
| | Formulation | Example C3 |
| | (amount wt %) | (amount wt %) |
| Liquid carrier | 25 | 25 |
| Dispersant | 4 | 5 |
| Sodium | 35 | 37.5 |
| bicarbonate | | |
| Calcium oxide | 1 | 1 |
| Zinc oxide | 2.4 | |
| OBSH (4,4′oxybis | 7.8 | 4 |
| (benzenesulfonylhydrazide) | | |
| TSSC (P-toluenesulfonylsemicarbazide) | 10 | |
| AZDC | 13.8 | 26.5 |
| Fumed silica (thickener) | 1 | 1 |

The formulations were assessed in the torque rheometer as described in Test 1. In this regard, 1 wt % of a liquid formulation to be assessed was added to 65 g of a dry blend of PVC, stabilised by a proprietary calcium-zinc stabiliser package. The tests were conducted at 190° C., a speed of 30 rpm and a time of 6 minutes. The resulting polymer melt was removed from the mixer, pressed between two metal plates and allowed to cool in a Carver cold press.

The colours of the resulting press-outs made using the Example 7 and Comparative Example C3 formulations were assessed as was the colour of the dry blend of calcium-zinc stabilised PVC. Results are provided in Table 5.

TABLE 5

| Test Material | L*(D65) | a*(D65) | b*(D65) |
|---|---|---|---|
| Dryblend Of calcium-zinc stabilized | 81.25 | 2.64 | 18.04 |
| PVC | | | |
| Foam produced using Example 7 | 79.47 | 2.13 | 15.41 |
| formulation | | | |
| Foam produced using Example C3 | 74.5 | 3.01 | 17.55 |
| formulation | | | |

It is clear from Table 5 that use of the Example 7 formulation leads to an improvement in colour compared to the Example C3 formulation which includes a higher level of AZDC.

Other liquid formulations for use in foaming PVC are detailed in Table 6.

TABLE 6
Amounts in formulation (wt %)

| | | | Example | Example | Example | Example |
|---|---|---|---|---|---|---|
| | Example 8 | Example 9 | 10 | 11 | 12 | 13 |
| Liquid Carrier | 25 | 24 | 24 | 24 | 24 | 24 |
| Dispersant | 4 | 4 | 4 | 4 | 4 | 4 |
| Sodium Bicarbonate | 35 | 32 | 32 | 32 | 32 | 32 |
| Calcium Oxide | 0.9 | 0.9 | 0.9 | 0.9 | 0.9 | 0.9 |
| Zinc oxide | 8.9 | 8.9 | 8.9 | 8.9 | 8.9 | 8.9 |
| OBSH | 6.8 | 6.8 | 6.8 | 6.8 | 6.8 | 6.8 |
| TSSC | 18.4 | 18.4 | 18.4 | 18.4 | 18.4 | 18.4 |
| Fumed Silica | 1 | — | — | — | — | — |
| Talc (Magnesium | — | 5 | — | — | — | — |
| Silicate) | | | | | | |
| Filler (calcium | — | — | 5 | — | — | — |
| carbonate) | | | | | | |
| Acrylic process aid | — | — | — | 5 | — | — |
| Stearic acid | — | — | — | — | 5 | — |
| Decanoic acid | — | — | — | — | — | 5 |

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method of preparing a foamed thermoplastic polymer, the method comprising contacting a chemical blowing agent (A) which is a semi-carbazide with a thermoplastic polymer or a precursor of a thermoplastic polymer.

2. (canceled)

3. (canceled)

4. A method according to claim 1, wherein said blowing agent (A) is of formula 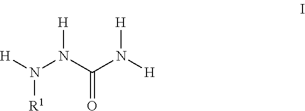
wherein R¹ represents a sulphonyl group containing moiety and R¹ represents a moiety 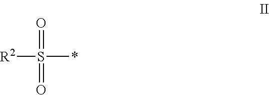
wherein the * represents the bond of moiety II by which R¹ is bonded to the nitrogen atom of the semi-carbazide of Formula I; and R² includes an optionally-substituted phenyl moiety, wherein said phenyl moiety is substituted by one or more alkyl moieties.

5. (canceled)

6. A method according to claim 1, wherein said blowing agent (A) is p-toluenesulfonyl semi-carbazide.

7. A method according to claim 4, wherein the method comprises contacting the chemical blowing agent (A) with said thermoplastic polymer during melt processing of the polymer and a liquid formulation comprising chemical blowing agent (A) is introduced directly into an extruder, wherein said liquid formulation is comprised of 20 to 30 wt % carrier, 8 to 25 wt % toluenesulfonyl semi-carbazide and 25 to 65 wt % bicarbonate, and wherein said thermoplastic polymer is melt-processed at a temperature of at least 170° C. and at a temperature not exceeding 250° C.

8. A method according to claim 7, wherein said thermoplastic polymer comprises PVC.

9. A method according to claim 8, wherein a stabiliser formulation is included with said thermoplastic polymer which comprises PVC for stabilising the PVC against degradation; wherein, said stabiliser formulation comprises a barium or calcium compound in combination with a zinc compound.

10. (canceled)

11. (canceled)

12. A method according to claim 4, wherein at least 0.05 parts by weight (pbw) of said chemical blowing agent (A) is contacted with 100 pbw of said thermoplastic polymer in the method and less than 0.4 pbw of said chemical blowing agent (A) is contacted with 100 pbw of said thermoplastic polymer in the method, wherein the sum of the pbw of calcium and zinc compounds which are associated with 100 pbw of said thermoplastic polymer in the method is at least 0.01 pbw and wherein at least 0.2 pbw of bicarbonate is contacted with 100 pbw of said thermoplastic polymer in the method.

13. (canceled)

14. (canceled)

15. A method according to claim 4, wherein the sum of the pbw of exothermic chemical blowing agents contacted with 100 pbw of said thermoplastic polymer in the method is at least 0.08 pbw and is less than 1.0 pbw; and wherein 0 pbw of azodicarbonamide is contacted with said thermoplastic polymer in the method.

16. (canceled)

17. (canceled)

18. A formulation for foaming a thermoplastic polymer, said formulation comprising:
a carrier; and
a chemical blowing agent (A) which is a semi-carbazide, wherein said chemical blowing agent (A) may have any feature of said chemical blowing agent (A) described in claim 1.

19. A formulation according to claim 18, wherein said formulation is a liquid formulation which includes a liquid carrier which is an organic liquid which has a boiling point of greater than 150° C. and wherein said carrier is selected from oils, esters and fatty acids; wherein, in said formulation, the ratio of the parts by weight (pbw) of carrier divided by the pbw of said blowing agent (A) is in the range 0.5 to 5; wherein said formulation includes at least 5 wt % of said chemical blowing agent (A) and less than 25 wt % of chemical blowing agent (A).

20. (canceled)

21. (canceled)

22. (canceled)

23. A formulation according to claim 18, wherein said formulation includes one or a plurality of endothermic chemical blowing agents which include a bicarbonate wherein the ratio of the sum of the wt % of exothermic blowing agent(s) divided by the sum of the wt % of endothermic blowing agent(s) in said formation is in the range 0.1 to 1; and the sum of the amounts of solid materials dispersed in the formulation is in the range of 50 to 85 wt %.

24. (canceled)

25. A formulation according to claim 23, wherein said formulation includes at least 15 wt % carrier; less than 40 wt % carrier; at least 12 wt %, of exothermic blowing agents and 30 wt % or less of exothermic blowing agents; and a chemical blowing agent (B) which is an exothermic chemical blowing agent, which is a hydrazide.

26. A formulation according to claim 18, wherein said formulation includes 0 wt % of azodicarbonamide (AZDC), and wherein said blowing agent (A) is p-toluenesulfonyl semi-carbazide.

27. A formulation according to claim 18, wherein said formulation is a liquid formulation which includes:
15 to 40 wt % carrier;
30 to 70 wt % of a bicarbonate;
5 to 25 wt %, of chemical blowing agent (A).

28. A formulation according to claim 18, wherein said formulation is a liquid formulation which includes:
20 to 30 wt % of carrier;
8 to 25 wt % of toluenesulfonyl semi-carbazide;
a bicarbonate, wherein the total amount of bicarbonate in the formulation is in the range 25 to 65 wt %.

29. A formulation according to claim 28, wherein said formulation is a liquid formulation which includes 1 to 10 wt % of zinc oxide.

30. A foamed product comprising:
(i) a thermoplastic polymer which is PVC; and
(ii) a thiosulfinate.
wherein said foamed products includes at least 100 ppm of thiosulfinate and 1000 ppm or less of thiosulfinate.

31. (canceled)

32. A formulation according to claim 29, wherein said liquid formulation includes 2 to 10 wt % of oxybissulphonyl hydrazide.

33. A formulation according to claim 19, wherein said formulation includes:
20 to 30 wt % of carrier;
8 to 25 wt % of toluenesulfonyl semi-carbazide;
a bicarbonate, wherein the total amount of bicarbonate in the formulation is in the range 25 to 55 wt %, wherein said formulation includes 1 to 10 wt % of zinc oxide.

34. A formulation according to claim 28, wherein said formulation is a liquid formulation which includes 0.5 to 3 wt % of calcium oxide and 1 to 10 wt % of zinc oxide, wherein said liquid formulation includes 2 to 10 wt % of oxybissulphonyl hydrazide.
